(19) United States
(12) Patent Application Publication
(10) Pub. No.: US 2025/0064092 A1
(43) Pub. Date: Feb. 27, 2025

(54) METHOD FOR MAKING PARTICLES FROM CHICORY ROOT

(71) Applicant: WHOLEFIBER HOLDING B.V., Emmeloord (NL)

(72) Inventors: Frederik Simon KAPER, Emmeloord (NL); Karel Melle KAPER, Emmeloord (NL); Lucas BRAMER, Emmeloord (NL); Willem WÜRDEMANN, Emmeloord (NL)

(21) Appl. No.: 18/708,045

(22) PCT Filed: Nov. 7, 2022
(86) PCT No.: PCT/EP2022/081011

§ 371 Date: May 7, 2024

(30) Foreign Application Priority Data
Nov. 8, 2021 (NL) 2029659

(51) Int. Cl. A23L 5/20; A23L 5/00

(52) U.S. Cl. CPC A23L 5/23; A23L 5/51

(57) ABSTRACT

A method for providing dried chicory particles made up of intact plant cells, including the following steps:
a. providing chicory roots;
b. cutting the roots in pieces, having a thickness between 1.5 cm and 8 cm;
c. leaving the pieces for 60-500 seconds to release a bitter tasting exudate and yielding debittered pieces;
d. wash off the bitter tasting exudate from the debittered pieces with an aqueous solution containing antioxidant and/or acidulant to yield washed pieces;
e. chopping the washed pieces into particles having a particle size between 1.5 mm and 10 mm;
f. performing a heat treatment of the particles followed by or in combination with drying of the particles to provide dried chicory particles, and wherein no heating step is conducted before step f.

### FIELD OF THE INVENTION

The present invention relates to a method for the preparation of particles from chicory root. Chicory root is a vegetable comprising high amounts of inulin and other soluble and insoluble fibers. It is containing the highest content of dietary fibers in the plant kingdom (see for example https://pubmed.ncbi.nlm.nih.gov/32199025/) and is considered a source of multiple prebiotic fibers that may contribute to significant health benefits to consumers through improvement of the quality of the gut microbiome, leading to gastrointestinal and metabolic health.

### BACKGROUND OF THE INVENTION

A disadvantage is however the exudation of bitter tasting components upon wounding or cutting the root, as a reaction of self-defense. This makes it difficult to prepare a palatable vegetable from chicory which is appreciated by humans and animals as food or nutritional supplement.

As used herein, the phrase “bitter tasting components” refers to sesquiterpenes. The sesquiterpenes may be sesquiterpene lactones produced by plants belonging to the Asteraceae family, such as exuded by lettuce, endive, chicory, global artichoke, Jerusalem artichoke, sunflower etc. Many plants of the Asteraceae family have ducts or laticifers, containing enzymes and their precursors to form sesquiterpene lactones. These sesquiterpene lactones may be exudated by plants upon wounding of the plant organs or tissues. The bitter taste of the plants may be associated with the exudated sesquiterpene lactones. Sesquiterpene lactones may include but are not limited to guaianolides, eudesmanolides, or germacranolides. The guaianolides may include at least one of lactucin, 8-deoxylactucin, and lactucopicrin. WO2014/172486 describes process for preparing a dry product from chicory root.

The process comprises multiple steps of washing the root, tuber or leaves, cutting the top or tail, heating, rinse the pieces in water, followed by dicing, shredding, dipping in an aqueous solution containing antioxidants and drying and finally milling into a dried powder. An end product of a fiber-rich powder is obtained.

Although the process results in a palatable fiber-rich powder, there is a need for a more simple, effective process which is providing particles from chicory that can be used as a medicament or food supplement.

### SUMMARY OF THE INVENTION

The invention relates to a minimal processing method for providing dried chicory particles made up of intact plant cells, comprising the following steps:
a. Providing chicory roots;
b. Cutting the roots in pieces, having a thickness between 1.5 cm and 8 cm;
c. Leaving the pieces for 60-500 seconds to release a bitter tasting exudate and yielding debittered pieces;
d. Wash off the bitter tasting exudate from the debittered pieces with an aqueous solution containing antioxidant and/or acidulant to yield washed pieces;
e. Chopping the washed pieces into particles having a particle size between 1.5 mm and 10 mm;
f. Performing a heat treatment of the particles followed by or in combination with drying of the particles to provide dried chicory particles,
and wherein no heating step is conducted before step f.

The method has the advantage that bitter components are removed effectively from the pieces and do not end up in the fibre-rich product. Further the process is simple, and can be scaled to an industrial scale, making the minimally processed, prebiotic products available as a vegetable, food, food-ingredient, nutritional supplement or medicament.

### DETAILED DESCRIPTION OF THE INVENTION

The process according to the invention has a number of steps that are conducted preferably sequentially. Preferably no heating step is conducted before step f, wherein the temperature of the solid chicory roots/pieces reaches a temperature of more than 44 celc.

First chicory roots are provided, which are preferably washed with water. Chicory (Cichorium intybus L.) is a widely used medicinal and industrial plant from the Asteraceae family. Chicory roots also cover genetically modified chicory plants which may have increased or decreased levels of guaianolide oxalate content, like for example published in GN Crops & Food 2020, VOL 11, no 1, pages 54-66.

Chicory roots typically have a conical shape, having a base plane, where the root is connected to the leaves of the root and an apex. The length of the root is a few times larger than largest circumference of the root close to the base plane of the root. The length of the root typically ranges between 15-20 cm for clay and between 20-30 cm for sandy soils. The roots have a length axis ranging from the apex to the centre of the base plane. Ideally the roots are cut perpendicular to the length axis of the root, such that the disks of root are formed.

The roots are cut, ending up in pieces having a thickness of at least 1.5 cm, preferably at least 2.5 cm, more preferably at least 3 cm, most preferably at least 3.5 cm.

The thickness is typically less than 8 cm, preferably less than 7 cm, more preferably less than 6.5 cm, most preferably less than 6 cm.

In the cutting of the roots, some fines can be formed having a very low thickness. It has to be understood that at least 80 wt. % of the pieces have a thickness between 1.5 cm and 8 cm, preferably at least 90 wt. % of the pieces, more preferably at least 95 wt. %, or at least 98 wt. % of the pieces have a thickness between 1.5 cm and 8 cm. The thickness is defined as the distance through a piece of chicory root, as distinct from width or height of the piece. The thickness is the smallest distance between the two (2) cut surfaces of the piece.

A result of cutting the chicory root into a piece having a thickness between 1.5 and 8 cm, preferably between 2.5 and 7, more preferably between 3 and 6.5 or between 3.5 and 6 cm is that bitter components are exudated as a bitter tasting exudate from the piece supported by the turgor present in the root piece. When the thickness is too low, the bitter components remain inside the pieces, when the thickness is too great, the turgor is insufficient to remove all the bitter components from the inner part of the pieces of the chicory root.

After cutting the roots into pieces, the pieces receive time for exudating the bitter components as a bitter tasting exudate. The time needed for exudating the bitter components typically ranges between 60 and 500 seconds, preferably between 70 and 450 seconds. The pieces obtained after exudating bitter components are defined as debittered pieces.

By cutting the roots into pieces and giving time for exudating bitter components at least 70 wt. % of the potentially bitter tasting materials are released from the pieces, preferably at least 80, 85 or 90% of the bitter tasting materials, relative to the total amount of bitter tasting materials potentially present in the chicory root. For Chicory root, the amount of potential bitter tasting components is about 0.4 wt. % of the weight of the root.

In step d) the debittered pieces are washed with an aqueous solution containing an antioxidant and/or acidulant to yield washed pieces.

The washing primarily removes exudated bitter components attached to the surface of the debittered pieces.

The aqueous solution may include at least one substance selected from the group consisting of: ascorbic acid, citric acid, erythorbic acid, lactic acid, gluconic acid, malic acid, potassium ascorbate, potassium citrate, potassium erythorbate, potassium lactate, potassium gluconate, sodium ascorbate, sodium citrate, sodium erythorbate, sodium lactate, sodium gluconate, sodium malate, cyclodextrin, sodium pyrophosphate, sodium acid pyrophosphate, potassium pyrophosphate, potassium acid pyrophosphate, L-cysteine, L-cysteine-HCL, thiol containing peptides, extract, proteases, sodium bisulfite, potassium bisulfite, EDTA, CaCl₂, Ca-lactate, Ca-gluconate, and Ca-lactate gluconate.

Preferably the aqueous solution contains at least one of ascorbic acid and citric acid.

The amount of residual bitter components in the washed pieces is preferably less than 0.12 wt. %, preferably less than 0.05 wt. %, less than 0.03 wt. % most preferably less than 0.025 wt. % relative to the weight of the washed pieces.

The washed pieces preferably do not contain residual exudated bitter components, nor residual antioxidant and/or acidulant. Optionally an additional washing step is performed with water to remove such residual components.

In step e), the washed pieces are chopped to particles having a particle size of at least 1.5 and less than 10 mm.

### Size of Particles

Preferably, at least 50 wt. % 60 wt. %, at least 70 wt. %, at least 80 wt. %, at least 90 wt. %, at least 95 wt. %, at least 98 wt. %, at least 99 wt. % or 100 wt. % of the product according to the invention are particles having particle sizes in the range of 1.5 to 10 mm. Preferably the chopped particles comprise inulin and intact cell walls comprising pectin, hemi-cellulose and cellulose, whereby the inulin is contained within the cell walls.

Preferably, the particles having particle sizes in the range of 1.5 to 10 mm may comprise particles having sizes in the range of 1.6 to 8.0 mm. In some embodiments, the particles having particle-sizes in the range of 1.5 to 10 mm may comprise particles having sizes in the range of 1.5 to 4.0 mm. In some embodiments, the particles having particle sizes in the range of 1.5 to 10 mm may comprise particles having sizes in the range of 4.0 to 8.0 mm.

Preferably, at least 50 wt. %, at least 60 wt. %, at least 70 wt. %, at least 80 wt. %, at least 90 wt. %, at least 95 wt. %, at least 98 wt. %, at least 99 wt. % or 100 wt. % of the product according to the invention are the particles having particle sizes in the range of 1.5 to 8.0 mm and comprising inulin and intact cell walls comprising pectin, hemi-cellulose and cellulose, whereby the inulin is contained within the cell walls.

In an embodiment, at least 50 wt. %, at least 60 wt. %, at least 70 wt. %, at least 80 wt. %, at least 90 wt. %, at least 95 wt. %, at least 98 wt. %, at least 99 wt. % or 100 wt. % of the product according to the invention are the particles having particle sizes in the range of 1.5 to 4.0 mm and comprising inulin and intact cell walls comprising pectin, hemi-cellulose and cellulose, whereby the inulin is contained within the cell walls.

In an embodiment, at least 50 wt. %, at least 60 wt. %, at least 70 wt. %, at least 80 wt. %, at least 90 wt. %, at least 95 wt. %, at least 98 wt. %, at least 99 wt. % or 100 wt. % of the product according to the invention are the particles having particle sizes in the range of 4.0 to 8.0 mm and comprising inulin and intact cell walls comprising pectin, hemi-cellulose and cellulose, whereby the inulin is contained within the cell walls.

The particles may have various shapes, e.g. close to spherical or polyhedron such as cuboid, cube etc., but preferably do not have a fibrous shape. In a fibrous shaped particle, the ratio between its largest dimension (normally referred as length) is very large with respect to its smallest dimension (normally referred as thickness). A fibrous shaped particle also has a low weight and a low volume with respect to its largest dimension.

Preferably, at least 50 wt. %, at least 60 wt. %, at least 70 wt. %, at least 80 wt. %, at least 90 wt. %, at least 95 wt. %, at least 98 wt. %, at least 99 wt. % or 100 wt. % of the product according to the invention are particles having a ratio between the largest dimension and the smallest dimension in the range of at most 4, at most 3 or at most 2.

Preferably, the particles have shapes which have a low surface area to volume ratio.

Preferably, at least 50 wt. %, at least 60 wt. %, at least 70 wt. %, at least 80 wt. %, at least 90 wt. %, at least 95 wt. %, at least 98 wt. %, at least 99 wt. % or 100 wt. % of the product according to the invention are particles having a surface area to volume (SA/V) ratio of at most 6 mm⁻¹, 5 mm⁻¹, 4 mm⁻¹, 3 mm⁻¹, 2 mm⁻¹ or 1 mm⁻¹.

The SA/V ratio of a particle may be calculated by approximating the particle as a cube or a sphere. Evidently, particles smaller than 200 micrometer (0.2 mm) have, when occurring as cubes with a side of 0.2 mm or as a sphere with a radius 0.1 mm), a (SA/V) ratio of over 30.

Chopping of particles can be done with for example a vegetable chopper or dicer machine, like for example a dicer of the companies FAM, Hobart, Foodlogistik and others.

After chopping the washed pieces into particles, a heat treatment is conducted. Preferably the heat treatment takes place within 1 hour of chopping of the pieces, preferably within 10 minutes, 5, 4, 3, or 1 minute of chopping. The heat treatment is carried out such that the temperature of the particles arrives at a temperature between 45 and 95° C.

Optionally before the heat treatment, the particles can be sprayed with an aqueous solution containing an antioxidant, for example citric acid or ascorbic acid. In the case where spraying of a solution containing antioxidant is performed, the drying time can be delayed to a time longer than 10 minutes, for example 1 hour or even 1 day. Spraying with an aqueous solution has however the disadvantage that more water needs to be removed in the drying step, which takes time and energy.

Before drying, the particles typically have a moisture content between 60 and 80 wt. %.

The heat treatment can take place with hot air having a temperature between 100 and 150° C. The heat treatment can be carried out concurrent with a drying step, wherein residual water is evaporated from the particles to prepare dried particles of chicory root. Drying can be performed with for example a conveyer dryer, fluid bed dryer or flash dryer. The drying process can be performed with hot air having a temperature between 100 and 150° C. and an air velocity, preferably with hot air having a relative humidity (RH) between 10-45% at 100° C.

Drying of the particles can go through different stages. In a first stage, particles preferably are heated to a wet bulb temperature of 45-60° C. during 1-30 minutes. Subsequently, the particles can be further heated to a temperature between 60-95° C. giving dried particles.

Preferably the temperature of the particles ranges between 47 and 90° C., more preferably between 50 and 88° C. The drying time ranges preferably between 5 and 25 minutes, or between 7 and 20 minutes.

In an embodiment the drying step can take place in 2 or 3 temperature zones: a first zone is heated with hot air having a temperature between 100 and 150° C. to remove the majority of water from the product, whereby the temperature of the product does not exceed 60° C. In a second zone and third zone, the temperature of the zones is gradually increased to 75° C. and subsequently to a maximum 95° C. to remove the residual amount of water, while preventing overheating of the final product.

The dried chicory particles preferably have a water content of less than 10 wt. % water, and a bitter component content of less 0.05 wt. %, relative to the weight of the dried particles.

Preferably the dried chicory particles have a water content between 5 and 8 wt. %.

The dried particles have a low content of bitter components (sesquiterpenes): the dried particles preferably have less than 0.12 wt. %, preferably less than 0.05 wt. %, less than 0.03 wt. % most preferably less than 0.025 wt. % of sesquiterpenes relative to the weight of the dried particles.

The invention also relates to dried chicory particles which can be used as prebiotic products available as a vegetable, food, food-ingredient, nutritional supplement or medicament.

What is claimed is:

1. A method for providing dried chicory particles made up of intact plant cells, comprising the following steps:
a. providing chicory roots;
b. cutting the roots in pieces, having a thickness between 1.5 cm and 8 cm;
c. leaving the pieces for 60-500 seconds to release a bitter tasting exudate and yielding debittered pieces;
d. wash off the bitter tasting exudate from the debittered pieces with an aqueous solution containing antioxidant and/or acidulant to yield washed pieces;
e. chopping the washed pieces into particles having a particle size between 1.5 mm and 10 mm;
f. performing a heat treatment of the particles followed by or in combination with drying of the particles to provide dried chicory particles,
and wherein no heating step is conducted before step f.

2. The method according to claim 1, wherein the heat treatment in step f is performed within 10 minutes from chopping the pieces.

3. The method according to claim 1, wherein the thickness of the pieces ranges between 2.5 and 7.5 cm, preferably between 3 and 7 cm, more preferably between 3.5 and 6.5 cm.

4. The method according to claim 1, wherein at least 80 wt. % of the pieces have a thickness between, 2.5 and 7 cm, more preferably between 3 and 6.5 or between 3.5 and 6 cm.

5. The method according to claim 1, wherein washing step d is carried out with an aqueous solution containing at least one of ascorbic acid and citric acid.

6. The method according to claim 1, wherein the amount of the bitter components in the washed pieces is preferably less than 0.12 wt. %, preferably less than 0.05 wt. %, less than 0.03 wt. % most preferably less than 0.025 wt. % relative to the weight of the washed pieces.

7. The method according to claim 1, wherein the heat treatment in step f is carried out such that the temperature of the particles arrives at a temperature between 45 and 95° C.

8. The method according to claim 1, wherein the heat treatment in step f is carried out such that the temperature of the particles ranges between 47 and 90° C., more preferably between 50 and 88° C., and wherein the particles are dried with a drying time ranging preferably between 1 and 30 minutes, 5 and 25 minutes, or between 7 and 20 minutes.

9. The method according to claim 1, wherein the particles have a particle size of at least 1.5 and less than 10 mm, preferably a particle size between 1.6 mm and 8 mm.

10. The method according to claim 1, wherein the heat treatment takes place with hot air having a temperature between 100 and 150° C. during 1-30 minutes, preferably with hot air having a relative humidity (RH) between 10-45% at 100° C.

11. The method according to claim 1, wherein the dried chicory particles have a residual water content of less than 10 wt. % water, and a bitter component content of less 0.05 wt. %, relative to the weight of the dried particles.

12. The method according to claim 1, wherein the dried chicory particles have a residual water content between 5 and 8 wt. %.

13. The method according to claim 1, wherein the antioxidant contains at least one of ascorbic acid and citric acid.

14. The method according to claim 2, wherein the thickness of the pieces ranges between 2.5 and 7.5 cm, preferably between 3 and 7 cm, more preferably between 3.5 and 6.5 cm, and wherein at least 80 wt. % of the pieces have a thickness between, 2.5 and 7 cm, more preferably between 3 and 6.5 or between 3.5 and 6 cm.

15. The method according to claim 14, wherein washing step d is carried out with an aqueous solution containing at least one of ascorbic acid and citric acid, and wherein the amount of the bitter components in the washed pieces is preferably less than 0.12 wt. %, preferably less than 0.05 wt. %, less than 0.03 wt. % most preferably less than 0.025 wt. % relative to the weight of the washed pieces.

16. The method according to claim 15, wherein the heat treatment in step f is carried out such that the temperature of the particles arrives at a temperature between 45 and 95° C., and wherein the heat treatment in step f is carried out such that the temperature of the particles ranges between 47 and 90° C., more preferably between 50 and 88° C., and wherein the particles are dried with a drying time ranging preferably between 1 and 30 minutes, 5 and 25 minutes, or between 7 and 20 minutes.

17. The method according to claim 16, wherein the particles have a particle size of at least 1.5 and less than 10 mm, preferably a particle size between 1.6 mm and 8 mm, and wherein the heat treatment takes place with hot air having a temperature between 100 and 150°° C. during 1-30 minutes, preferably with hot air having a relative humidity (RH) between 10-45% at 100° C.

18. The method according to claim 17, wherein the dried chicory particles have a residual water content of less than 10 wt. % water, and a bitter component content of less 0.05 wt. %, relative to the weight of the dried particles, and wherein the dried chicory particles have a residual water content between 5 and 8 wt. %.

19. The method according to claim 18, wherein the antioxidant contains at least one of ascorbic acid and citric acid.
